(19) United States
(12) Patent Application Publication
(10) Pub. No.: US 2016/0314730 A1
(43) Pub. Date: Oct. 27, 2016

(54) PERMISSIONS BASED CONTROL OF THIRD PARTY SELECTION OF DISPLAY OPERATING MODE

(71) Applicant: Pixtronix, Inc., San Diego, CA (US)

(72) Inventor: Matthew Brian Sampsell, San Jose, CA (US)

(21) Appl. No.: 14/697,508

(22) Filed: Apr. 27, 2015

(51) Int. Cl. G09G 3/20; G09G 3/00

(52) U.S. Cl. CPC G09G 3/2003; G09G 3/007; G09G 2320/0606

(57) ABSTRACT

This disclosure provides systems, methods, and apparatus for altering the selected operating mode and image formation characteristics of a content item displayed on a display device. The content item can include a license header that includes a permission code and a preferred operating mode. The preferred operating mode can specify a selected operating mode or image formation characteristics preselected for display of the content item. Control logic can check the permission code against a permission code table to determine one or more permissions associated with the content item. A valid permission code can allow the control logic to alter the current selected operating mode and/or image formation characteristics based on the selected operating mode and/or image formation characteristics specified by the preferred operating mode in the license header.

### TECHNICAL FIELD

This disclosure relates to the field of imaging displays, and in particular to processes for setting display modes and image formation characteristics.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

EMS-based display apparatus can include display elements that modulate light by selectively moving a light blocking component into and out of an optical path through an aperture defined through a light blocking layer. Doing so selectively passes light from a backlight or reflects light from the ambient or a front light to form an image.

### SUMMARY

The systems, methods and devices of this disclosure each have several innovative aspects, no single one of which is solely responsible for the desirable attributes disclosed herein.

One innovative aspect of the subject matter described in this disclosure can be implemented in an apparatus. The apparatus can include a controller having a processor and a display. The processor can be configured to receive one or more of a user-provided operating mode selection parameter or a device-generated operating mode selection parameter. The processor can be configured to receive a content item for display, the content item including image data and metadata containing a license header having a permission code and a preferred operating mode. The processor can be configured to analyze the permission code, the preferred operating mode, and the one or more of the user-provided operating mode selection parameter or the device-generated operating mode selection parameter to determine the operating mode. The display can be configured to display the content item in the operating mode.

In some implementations, the operating mode can correspond to a set of image formation characteristics. The image formation characteristics can include at least one of bit depth, frame rate, color gamut, and brightness. The apparatus can further include a haptic output device, and wherein the operating mode includes access to an additional output function associated with the haptic output device. The apparatus can further include a computing device, and wherein the operating mode can include access to an audio file stored in a memory of the computing device. The user-provided operating mode selection parameter can include at least one of a display brightness level, a color level preference, a power consumption preference, and a mode selection. The device-generated operating mode selection parameter can include at least one of a power consumption preference, a battery power level parameter, a color level, a content type, and an application type. The device-generated operating mode selection parameter can depend on a color content of the image data, metadata of the image data, an ambient brightness, and a battery power level. The controller can be configured to analyze the permission code by comparing the permission code against a permission code table to determine one or more permissions. The permission code table can define a first permission and a second permission, wherein the first permission allows alteration of image formation characteristics based on the user-provided operating mode selection parameter, and the second permission allows alteration of image formation characteristics based on the user-provided operating mode selection parameter. The permission code table can also define a third permission, wherein the third permission allows access to an additional output function.

In some implementations, the permission code table can define a first permission and a second permission. The first permission can allow alteration of image formation characteristics based on the user-provided operating mode selection parameter, and the second permission can allow alteration of image formation characteristics based on the device-generated operating mode selection parameter. The permission code table can also define a third permission that allows access to an additional output function.

In some implementations, the values of the preferred operating mode, the user-provided operating mode selection parameter, and the device-generated operating mode selection parameter can represent an incremental level. The preferred operating mode can include a desired level, and analyzing the permission code, the preferred operating mode, and the one or more of the user-provided operating mode selection parameter or the device-generated operating mode selection parameter can include determining a maximum allowable number of incremental mode shifts between the one or more of the user-provided operating mode selection parameter or the device-generated operating mode selection parameter and the desired level.

In some implementations, the apparatus can include a display, a processor and a memory device. The processor can be configured to communicate with the display and process image data. The memory device can be configured to communicate with the processor. In some implementations, the apparatus can also include a driver circuit and a controller. The driver circuit can be configured to send at least one signal to the display. The controller can be configured to send at least a portion of the image data to the driver circuit. In some implementations, the apparatus includes an image source module that can be configured to send the image data to the processor. The image source module can include at least one of a receiver, transceiver, and transmitter. In some implementations, the apparatus can include an input device. The input device can be configured to receive input data and to communicate the input data to the processor.

Another innovative aspect of the subject matter described in this disclosure can be implemented in a method of operating a display apparatus. The method includes receiving, by a processor associated with a the display apparatus, one or more of a user-provided operating mode selection parameter or a device-generated operating mode selection parameter. The method further includes receiving, by the processor, a content item for display, the content item including image data and metadata containing a license header having a permission code and a preferred operating mode, and analyzing, by the processor, the permission code, the preferred operating mode, and the one or more of the user-provided operating mode selection parameter or the device-generated operating mode selection parameter to determine the operating mode. The method also includes displaying the content item in the selected operating mode.

In some implementations, the operating mode corresponds to a set of image formation characteristics. The image formation characteristics can include at least one of bit depth, frame rate, color gamut, and brightness. The selected operating mode can include activation of a haptic output device. The display apparatus can be associated with a computing device, and the selected operating mode can include access to an audio file stored in a memory of the computing device. The user-provided operating mode selection parameter can include at least one of a display brightness level, a color level preference, a power consumption preference, and a mode selection. The device-generated operating mode selection parameter can include at least one of a power consumption parameter, a battery power level parameter, a color level, a content type, and an application type. The device-generated operating mode selection parameter can depend on a color content of the image data, metadata of the image data, an ambient brightness, and a battery power level. Analyzing the permission code can comprise comparing the permission code against a permission code table to determine one or more permissions.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1A shows a schematic diagram of an example direct-view microelectromechanical systems (MEMS) based display apparatus.

FIG. 1B shows a block diagram of an example host device.

FIGS. 2A and 2B show views of an example dual actuator shutter assembly.

FIG. 3 shows a functional block diagram of example display apparatus control logic for permissions based control of third-party selection of display operating modes.

FIGS. 4A and 4B show example permission code tables.

FIG. 5 illustrates an example operation of permissions based control of third-party selection of display operating modes.

FIGS. 6A-6C show flow diagrams of example processes for permissions based control of third-party selection of display operating mode.

FIGS. 7A and 7B show system block diagrams of an example display apparatus that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that is capable of displaying an image, whether in motion (such as video) or stationary (such as still images), and whether textual, graphical or pictorial. The concepts and examples provided in this disclosure may be applicable to a variety of displays, such as liquid crystal displays (LCDs), organic light-emitting diode (OLED) displays, field emission displays, and electromechanical systems (EMS) and microelectromechanical (MEMS)-based displays, in addition to displays incorporating features from one or more display technologies.

The described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, wearable devices, clocks, calculators, television monitors, flat panel displays, electronic reading devices (such as e-readers), computer monitors, auto displays (such as odometer and speedometer displays), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, in addition to non-EMS applications), aesthetic structures (such as display of images on a piece of jewelry or clothing) and a variety of EMS devices.

The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

A display apparatus displays content based on a selected operating mode, which can include or be supplemented by individual image formation characteristics such as color bit depth, color gamut size, frame rate, display brightness, and the like. The display apparatus can include control logic that can receive a content item for display, and change the selected operating mode or the individual image formation characteristics based on metadata received with the content item. For example, the content item can include a license header that includes a permission code and a preferred operating mode. The preferred operating mode can specify a selected operating mode or image formation characteristics preselected for display of the content item. When the display apparatus receives the content item with the license header, the control logic can check the permission code in the license header against a permission code table to determine one or more permissions associated with the content item. A valid permission code will cause the control logic to alter the current selected operating mode and/or image formation characteristics based on the selected operating mode or image formation characteristics specified by the preferred operating mode in the license header.

Particular implementations of the subject matter described in this disclosure can be implemented to realize one or more of the following potential advantages. A display device according to this disclosure can allow the provider of a content item to specify a selected operating mode or image formation characteristics chosen for improved display of the content item. The content provider can be, without limitation, a product company, digital content producer, TV or movie producer, video game producer, the producer or seller of the device containing the display, or the producer or seller of the device itself. The content item can include news, entertainment content (such as a video, game or other multimedia entertainment content), social media updates, system notifications, or geographically relevant notifications such as local events or services. The provider can thus request that its content item is displayed according to the specified display settings even if they conflict with currently selected operating mode selection parameters. This gives the provider more versatility in communicating and drawing attention to the content, and it gives the display manufacturer more ways to provide services to content providers. Furthermore, it gives the user more versatility in the way he or she can receive content. For example, a user of the display device can set operating mode selection parameters for viewing primary content without having to change them to alter the display of various content items that may appear only for a limited duration, or in only a sub-region of the display, and that may have formats different from the primary content. The user may therefore view a content item according to the provider-specified display settings without departing from the operating mode selection parameters he or she has set. This can, for example, allow a battery saving mode with lower brightness, lower number of colors and/or lower frame rate to substantially continue while only briefly, and/or locally in a sub-region of the display, departing from the battery saving mode for the purposes of displaying the content item. Such a permission system can be configured to protect the user's privacy and limit the extent to which third parties can alter the display settings of the display device.

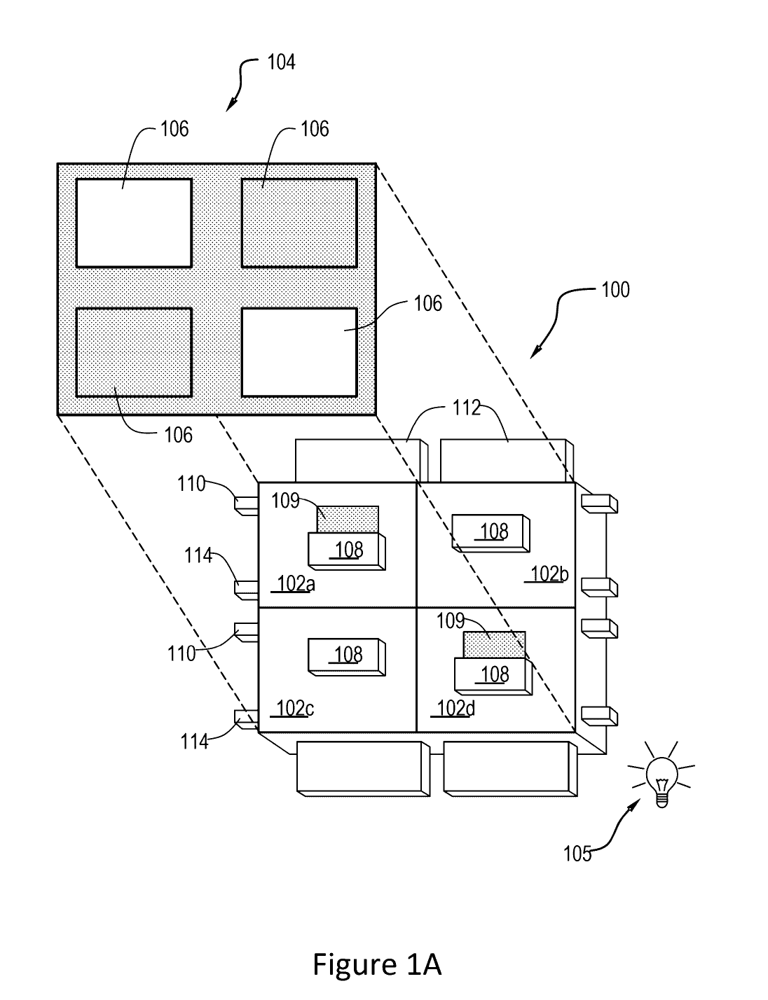

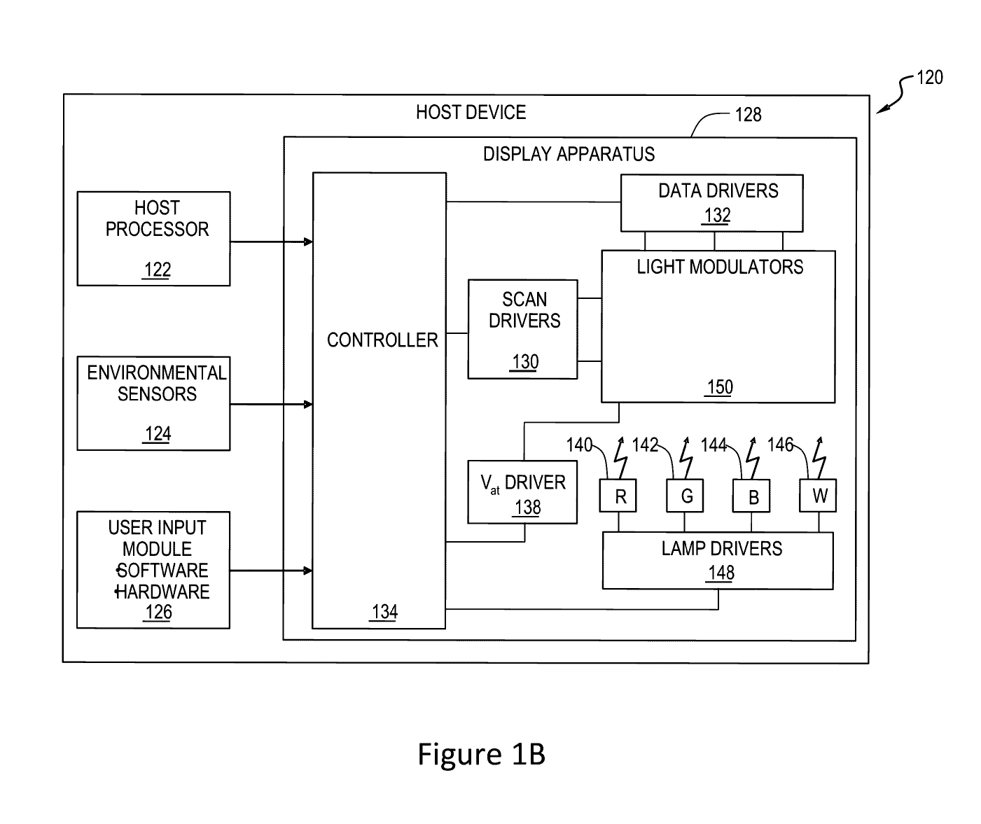

FIG. 1A shows a schematic diagram of an example direct-view MEMS-based display apparatus 100. The display apparatus 100 includes a plurality of light modulators 102a-102d (generally light modulators 102) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide a luminance level in an image 104. With respect to an image, a pixel corresponds to the smallest picture element defined by the resolution of image. With respect to structural components of the display apparatus 100, the term pixel refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the image can be seen by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or backlight so that each pixel can be uniformly illuminated. Transmissive direct-view displays are often built onto transparent substrates to facilitate a sandwich assembly arrangement where one substrate, containing the light modulators, is positioned over the backlight. In some implementations, the transparent substrate can be a glass substrate (sometimes referred to as a glass plate or panel), or a plastic substrate. The glass substrate may be or include, for example, a borosilicate glass, wine glass, fused silica, a soda lime glass, quartz, artificial quartz, Pyrex, or other suitable glass material.

Each light modulator 102 can include a shutter 108 and an aperture 109. To illuminate a pixel 106 in the image 104, the shutter 108 is positioned such that it allows light to pass through the aperture 109. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix coupled to the substrate and to the light modulators for controlling the movement of the shutters. The control matrix includes a series of electrical interconnects (such as interconnects 110, 112 and 114), including at least one write-enable interconnect 110 (also referred to as a scan line interconnect) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the write-enabling voltage, V_{WE}), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, such as transistors or other non-linear circuit elements that control the application of separate drive voltages, which are typically higher in magnitude than the data voltages, to the light modulators 102. The application of these drive voltages results in the electrostatic driven movement of the shutters 108.

The control matrix also may include, without limitation, circuitry, such as a transistor and a capacitor associated with each shutter assembly. In some implementations, the gate of each transistor can be electrically connected to a scan line interconnect. In some implementations, the source of each transistor can be electrically connected to a corresponding data interconnect. In some implementations, the drain of each transistor may be electrically connected in parallel to an electrode of a corresponding capacitor and to an electrode of a corresponding actuator. In some implementations, the other electrode of the capacitor and the actuator associated with each shutter assembly may be connected to a common or ground potential. In some other implementations, the transistor can be replaced with a semiconducting diode, or a metal-insulator-metal switching element.

FIG. 1B shows a block diagram of an example host device 120 (i.e., cell phone, smart phone, PDA, MP3 player, tablet, e-reader, netbook, notebook, watch, wearable device, laptop, television, or other electronic device). The host device 120 includes a display apparatus 128 (such as the display apparatus 100 shown in FIG. 1A), a host processor 122, environmental sensors 124, a user input module 126, and a power source.

The display apparatus 128 includes a plurality of scan drivers 130 (also referred to as write enabling voltage sources), a plurality of data drivers 132 (also referred to as data voltage sources), a controller 134, common drivers 138, lamps 140-146, lamp drivers 148 and an array of display elements 150, such as the light modulators 102 shown in FIG. 1A. The scan drivers 130 apply write enabling voltages to scan line interconnects 131. The data drivers 132 apply data voltages to the data interconnects 133.

In some implementations of the display apparatus, the data drivers 132 are capable of providing analog data voltages to the array of display elements 150, especially where the luminance level of the image is to be derived in analog fashion. In analog operation, the display elements are designed such that when a range of intermediate voltages is applied through the data interconnects 133, there results a range of intermediate illumination states or luminance levels in the resulting image. In some other implementations, the data drivers 132 are capable of applying a reduced set, such as 2, 3 or 4, of digital voltage levels to the data interconnects 133. In implementations in which the display elements are shutter-based light modulators, such as the light modulators 102 shown in FIG. 1A, these voltage levels are designed to set, in digital fashion, an open state, a closed state, or other discrete state to each of the shutters 108. In some implementations, the drivers are capable of switching between analog and digital modes.

The scan drivers 130 and the data drivers 132 are connected to a digital controller circuit 134 (also referred to as the controller 134). The controller 134 sends data to the data drivers 132 in a mostly serial fashion, organized in sequences, which in some implementations may be predetermined, grouped by rows and by image frames. The data drivers 132 can include series-to-parallel data converters, level-shifting, and for some applications digital-to-analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 139. In some other implementations, the common drivers 138, following commands from the controller 134, issue voltage pulses or signals to the array of display elements 150, for instance global actuation pulses which are capable of driving and/or initiating simultaneous actuation of all display elements in multiple rows and columns of the array.

Each of the drivers (such as scan drivers 130, data drivers 132 and common drivers 138) for different display functions can be time-synchronized by the controller 134. Timing commands from the controller 134 coordinate the illumination of red, green, blue and white lamps (140, 142, 144 and 146 respectively) via lamp drivers 148, the write-enabling and sequencing of specific rows within the array of display elements 150, the output of voltages from the data drivers 132, and the output of voltages that provide for display element actuation. In some implementations, the lamps are light emitting diodes (LEDs).

The controller 134 determines the sequencing or addressing scheme by which each of the display elements can be re-set to the illumination levels appropriate to a new image 104. New images 104 can be set at periodic intervals. For instance, for video displays, color images or frames of video are refreshed at frequencies ranging from 10 to 300 Hertz (Hz). In some implementations, the setting of an image frame to the array of display elements 150 is synchronized with the illumination of the lamps 140, 142, 144 and 146 such that alternate image frames are illuminated with an alternating series of colors, such as red, green, blue and white. The image frames for each respective color are referred to as color subframes. In this method, referred to as the field sequential color method, if the color subframes are alternated at frequencies in excess of 20 Hz, the human visual system (HVS) will average the alternating frame images into the perception of an image having a broad and continuous range of colors. In some other implementations, the lamps can employ primary colors other than red, green, blue and white. In some implementations, fewer than four, or more than four lamps with primary colors can be employed in the display apparatus 128.

In some implementations, where the display apparatus 128 is designed for the digital switching of shutters, such as the shutters 108 shown in FIG. 1A, between open and closed states, the controller 134 forms an image by the method of time division gray scale. In some other implementations, the display apparatus 128 can provide gray scale through the use of multiple display elements per pixel.

In some implementations, the data for an image state is loaded by the controller 134 to the array of display elements 150 by a sequential addressing of individual rows, also referred to as scan lines. For each row or scan line in the sequence, the scan driver 130 applies a write-enable voltage to the write enable interconnect 131 for that row of the array of display elements 150, and subsequently the data driver 132 supplies data voltages, corresponding to desired shutter states, for each column in the selected row of the array. This addressing process can repeat until data has been loaded for all rows in the array of display elements 150. In some implementations, the sequence of selected rows for data loading is linear, proceeding from top to bottom in the array of display elements 150. In some other implementations, the sequence of selected rows is pseudo-randomized, in order to mitigate potential visual artifacts. And in some other implementations, the sequencing is organized by blocks, where, for a block, the data for a certain fraction of the image is loaded to the array of display elements 150. For example, the sequence can be implemented to address every fifth row of the array of the display elements 150 in sequence.

In some implementations, the addressing process for loading image data to the array of display elements 150 is separated in time from the process of actuating the display elements. In such an implementation, the array of display elements 150 may include data memory elements for each display element, and the control matrix may include a global actuation interconnect for carrying trigger signals, from the common driver 138, to initiate simultaneous actuation of the display elements according to data stored in the memory elements.

In some implementations, the array of display elements 150 and the control matrix that controls the display elements may be arranged in configurations other than rectangular rows and columns. For example, the display elements can be arranged in hexagonal arrays or curvilinear rows and columns.

The host processor 122 generally controls the operations of the host device 120. For example, the host processor 122 may be a general or special purpose processor for controlling a portable electronic device. With respect to the display apparatus 128, included within the host device 120, the host processor 122 outputs image data as well as additional data about the host device 120. Such information may include data from environmental sensors 124, such as ambient light or temperature; information about the host device 120, including, for example, an operating mode of the host or the amount of power remaining in the host device's power source; information about the content of the image data; information about the type of image data; and/or instructions for the display apparatus 128 for use in selecting an imaging mode. The display apparatus 128 can use this information to create device-generated operating mode selection parameters. The display apparatus can, based on these device-generated operating mode selection parameters, set an operating mode or image formation characteristics.

In some implementations, the user input module 126 enables the conveyance of personal preferences of a user to the controller 134, either directly, or via the host processor 122. In some implementations, the user input module 126 is controlled by software in which a user inputs personal preferences, for example, color, contrast, power, brightness, content, and other display settings and parameters preferences. In some other implementations, the user input module 126 is controlled by hardware in which a user inputs personal preferences. In some implementations, the user may input these preferences via voice commands, one or more buttons, switches or dials, or with touch-capability. The plurality of data inputs to the controller 134 direct the controller to provide data to the various drivers 130, 132, 138 and 148 which correspond to optimal imaging characteristics. The display apparatus 128 can use the user input to create user-provided operating mode selection parameters. The display apparatus can, based on these user-provided operating mode selection parameters, set an operating mode or image formation characteristics.

The environmental sensor module 124 also can be included as part of the host device 120. The environmental sensor module 124 can be capable of receiving data about the ambient environment, such as temperature and or ambient lighting conditions. The sensor module 124 can be programmed, for example, to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment. This information can also be used to create device-generated operating mode selection parameters, which the display apparatus can use to set an operating mode or image formation characteristics.

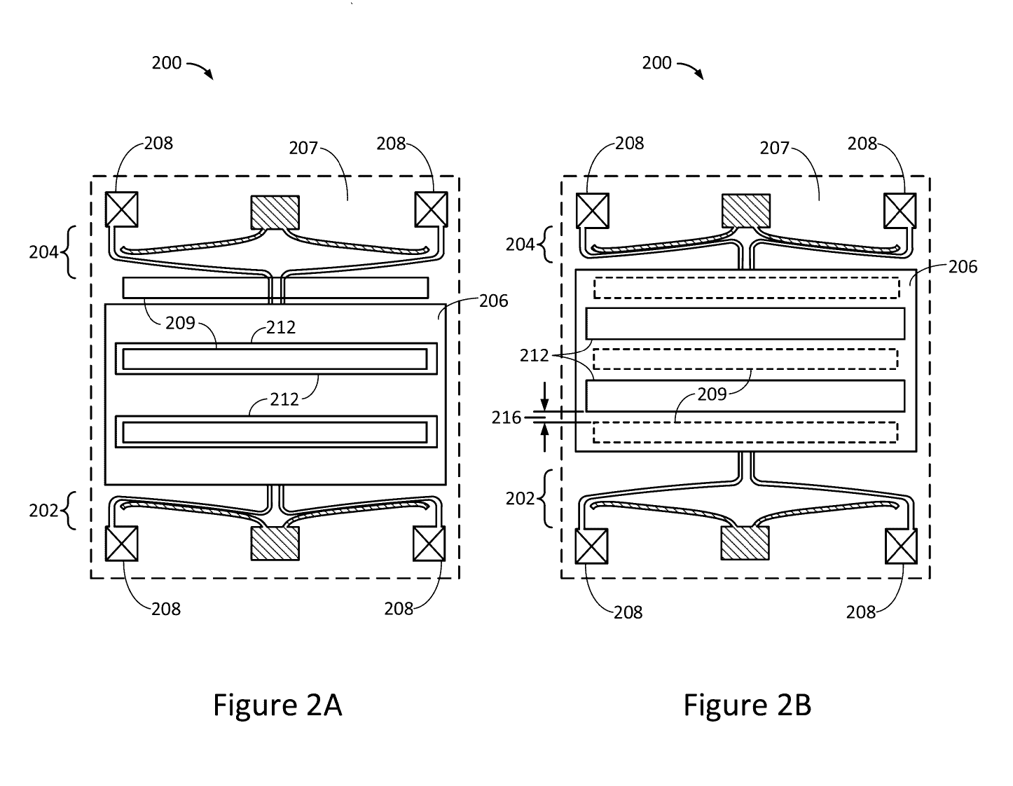

FIGS. 2A and 2B show views of an example dual actuator shutter assembly 200. The dual actuator shutter assembly 200, as depicted in FIG. 2A, is in an open state. FIG. 2B shows the dual actuator shutter assembly 200 in a closed state. The shutter assembly 200 includes actuators 202 and 204 on either side of a shutter 206. Each actuator 202 and 204 is independently controlled. A first actuator, a shutter-open actuator 202, serves to open the shutter 206. A second opposing actuator, the shutter-close actuator 204, serves to close the shutter 206. Each of the actuators 202 and 204 can be implemented as compliant beam electrode actuators. The actuators 202 and 204 open and close the shutter 206 by driving the shutter 206 substantially in a plane parallel to an aperture layer 207 over which the shutter is suspended. The shutter 206 is suspended a short distance over the aperture layer 207 by anchors 208 attached to the actuators 202 and 204. Having the actuators 202 and 204 attach to opposing ends of the shutter 206 along its axis of movement reduces out of plane motion of the shutter 206 and confines the motion substantially to a plane parallel to the substrate (not depicted).

In the depicted implementation, the shutter 206 includes two shutter apertures 212 through which light can pass. The aperture layer 207 includes a set of three apertures 209. In FIG. 2A, the shutter assembly 200 is in the open state and, as such, the shutter-open actuator 202 has been actuated, the shutter-close actuator 204 is in its relaxed position, and the centerlines of the shutter apertures 212 coincide with the centerlines of two of the aperture layer apertures 209. In FIG. 2B, the shutter assembly 200 has been moved to the closed state and, as such, the shutter-open actuator 202 is in its relaxed position, the shutter-close actuator 204 has been actuated, and the light blocking portions of the shutter 206 are now in position to block transmission of light through the apertures 209 (depicted as dotted lines).

Each aperture has at least one edge around its periphery. For example, the rectangular apertures 209 have four edges. In some implementations, in which circular, elliptical, oval, or other curved apertures are formed in the aperture layer 207, each aperture may have a single edge. In some other implementations, the apertures need not be separated or disjointed in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through the apertures 212 and 209 in the open state, the width or size of the shutter apertures 212 can be designed to be larger than a corresponding width or size of apertures 209 in the aperture layer 207. In order to effectively block light from escaping in the closed state, the light blocking portions of the shutter 206 can be designed to overlap the edges of the apertures 209. FIG. 2B shows an overlap 216, which in some implementations can be predefined, between the edge of light blocking portions in the shutter 206 and one edge of the aperture 209 formed in the aperture layer 207.

The electrostatic actuators 202 and 204 are designed so that their voltage-displacement behavior provides a bi-stable characteristic to the shutter assembly 200. For each of the shutter-open and shutter-close actuators, there exists a range of voltages below the actuation voltage, which if applied while that actuator is in the closed state (with the shutter being either open or closed), will hold the actuator closed and the shutter in position, even after a drive voltage is applied to the opposing actuator. The minimum voltage needed to maintain a shutter's position against such an opposing force is referred to as a maintenance voltage Vₘ.

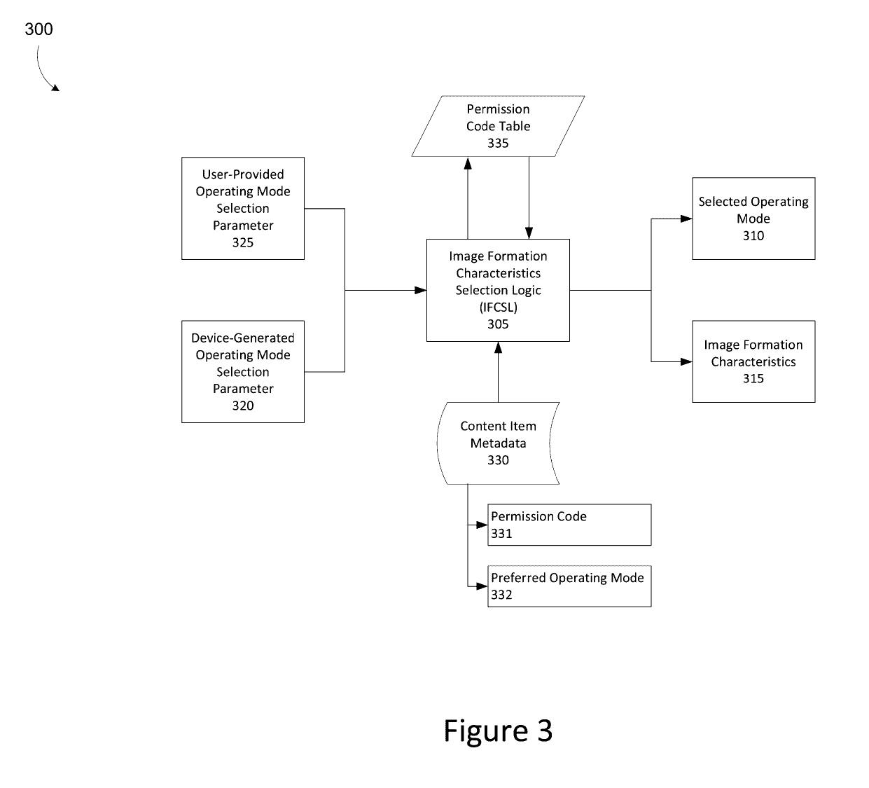

FIG. 3 shows a functional block diagram of display apparatus control logic 300 for permission based control of third-party selection of display operating modes. The display apparatus control logic 300 can include Image Formation Characteristic Selection Logic (IFCSL) 305. The IFCSL 305 can include a microcontroller, microprocessor, or other logic device included as part of, or distinct from, controller 134 shown in FIG. 1B. The IFCSL 305 can execute instructions to set a selected operating mode 310 and image formation characteristics 315 based on one or more device-generated operating mode selection parameters 320 and one or more user-provided operating mode selection parameters 325. The IFCSL 305 can further receive content item metadata 330 including a permission code 331 and a preferred operating mode 332. The IFCSL 305 can, based on one or more permissions associated with the permission code 331, disregard one or more operating mode selection parameters 320 and 325 that conflict with the preferred operating mode 332, and instead set the selected operating mode 310 and the image formation characteristics 315 based on the preferred operating mode 332. The permissions granted by the permission code 331 can be determined by reference to a permission code table 335. The IFCSL 305 can be preprogrammed with a default selected operating mode 310 and image formation characteristics 315, and change one or both according to one or more of the device-generated operating mode selection parameters 320, the user-provided operating mode selection parameter 325, and the content item metadata 330.

The IFCSL 305 can control image generation in various ways. At a low level, the IFCSL 305 can affect individual image formation characteristics 315. Image formation characteristics can include settings for the operation of the light modulators 150 and lamps 140, 142, 144, and 146. The image formation characteristics 315 can include, for example, color bit depth, color gamut size, frame rate, and display brightness. The color bit depth can represent the resolution of the color palate available to the display. The color bit depth can be expressed variously as per-pixel or per-color. For example, “true color” consists of 24 bits for three colors: 8 bits each for red, green, and blue. It is thus 24 bits per pixel, or 8 bits per color. In a monochrome example, a four-bit color bit depth can correspond to sixteen possible levels of grayscale in an individual pixel. And an eight-bit color depth can correspond to 256 possible grayscale levels, etc. The color gamut size can represent the breath of the color palate available to display. For example, a larger color gamut size may produce colors that appear more saturated or vivid than a smaller color gamut size. The frame rate can correspond to the number of image frames the display outputs per second. For example, a frame rate of a few frames per second may be adequate for reading text or viewing a static website, while twenty frames per second or more may be required for reproducing video smoothly. The display brightness can correspond to the intensity of the backlight. While several factors can contribute to perceived brightness of a display apparatus, in the context of the image formation characteristics 315 the display brightness relates to the current provided to the lamps 140, 142, 144, and 146 included in the backlight. The image formation characteristics 315 can include more or fewer settings as is appropriate for the particular display without departing from the scope of this disclosure.

The settings of the image formation characteristics 315 can affect power consumption. For example, in a field-sequential color display, each frame of a displayed image is generated by a number of subframes. The generation of each subframe requires a data loading stage and a light modulator actuation stage, each of which consumes power. Therefore, increasing the color bit depth or the frame rate will require increasing the number of subframes generated in a given time period, resulting in increased power consumption. The display brightness can also affect power consumption. Increasing the display brightness will drive more current to lamps 140, 142, 144, and 146. However, since many light sources such as LEDs have a brightness-per-current relationship that is non-linear, increasing the brightness will require increasing the current progressively, resulting in less efficient operation and a progressively greater power draw. Similarly, increasing the color gamut size may require brighter lamps, additional color lamps 140, 142, 144, and 146, more subframes, or a combination of the three, with a corresponding increase in power consumption.

The IFCSL 305 can control image generation at a higher level by setting a selected operating mode 310. For example, the selected operating mode 310 can be one of a vivid display mode, normal display mode, power saver mode, e-reader mode, and the like. Additional specialized modes are possible, including specialized modes for improved viewing of different types of imagery. For example, display modes for improved display of videos such as movies, games, or sports; or display modes for improved display of static images such as photographs, websites, or maps and GPS data. The selected operating mode 310 can correspond to a mode with preset image formation characteristics. For example, the vivid display mode can correspond to image formation characteristics 315 that can include a high color bit depth, high color gamut size, high frame rate, and high display brightness. The power saver mode may correspond to relatively low levels of these settings. The normal display mode may correspond to moderate settings for image formation characteristics that balance image quality with power savings. The e-reader mode may correspond to a white only backlight with low display brightness, and a frame rate of effectively zero, with the image refreshing based only on user input or entry of the device into a sleep or screen saver mode.

The IFCSL 305 can set the selected operating mode 310 and image formation characteristics 315 according to device-generated operating mode selection parameters 320. The device-generated operating mode selection parameters 320 include factors monitored by the IFCSL 305, such as the level of ambient light, battery level, and the content being displayed. The IFCSL 305 can set the selected operating mode 310 and adjust the image formation characteristics 315 based on the ambient light detected via environmental sensors 124 to conserve power while ensuring that displayed content is adequately discernable. For example, the IFCSL 305 can adjust the display brightness and other image formation characteristics 315 according to the ambient light. Similarly, for a display brightness that is low relative to the level of ambient light, the image quality benefits of a full color bit depth, color gamut size, or frame rate may not be realized, and so the IFCSL 305 may change those image formation characteristics 315 to conserve power. The IFCSL 305 can also set the selected operating mode 310 and adjust the image formation characteristics 315 based on the battery level. For example, the IFCSL 305 can set the selected operating mode 310 to the power saver mode when the battery level remaining falls below a predetermined threshold, such as 15%. The power saver mode may correspond to a set of image formation characteristics 315 configured to conserve power while maintaining reasonable image quality of the display. The IFCSL 305 can also set the selected operating mode 310 and adjust the image formation characteristics 315 based on the content being displayed. The IFCSL 305 can determine whether the primary content being displayed is text, image, or video and adjust the selected operating mode 310 accordingly.

The IFCSL 305 can set the selected operating mode 310 and image formation characteristics 315 according to user-provided operating mode selection parameters 325. A user can, via the user input module 126, set a selected display mode 310, manually input image formation characteristics 315, or both. For example, if the user knows she will not be able to charge the host device 120 for a long period of time, she may set the display apparatus 128 to the power saver mode even though the battery initially carries a full charge. In the same example, the user may select the power saver mode, but also set the display brightness to adjust according to the level of ambient light. In the same example, the user may manually adjust the display brightness to view a particular piece of content.

The IFCSL 305 can set the selected operating mode 310 and the image formation characteristics 315 according to content item metadata 330. The content item metadata 330 may include a license header having a permission code 331 and a preferred operating mode 332. The permission code 331 can correspond to one or more permissions that cause the IFCSL 305 to disregard one or more operating mode selection parameters 320 or 325, respectively, when setting the selected operating mode 310 or image formation characteristics 315. The preferred operating mode 332 can specify a selected operating mode 310 or image formation characteristics 315 chosen for improved display of the content in the content item. The IFCSL 305 can check the permission code 331 against the permission code table 335 to determine whether to disregard operating mode selection parameters in favor of the preferred operating mode 332.

The permissions granted can include one or more permissions corresponding to which operating mode selection parameters 320 and 325 the preferred operating mode 332 seeks to override. In some implementations, the permissions can include true/false or yes/no permissions. For example, a first permission may cause the IFCSL 305 to disregard device-generated operating mode selection parameters 320, and a second permission may cause the IFCSL 305 to disregard user-generated operating mode selection parameters 325. In another example, a third permission can allow access to additional input/output functions of the display apparatus 128 or host device 120, such as a haptic output (vibration), audio output, ambient light sensor, accelerometer, microphone, touch sensor, gesture sensor, or camera.

In some implementations, a permission can include a numeric permission. For example, a fourth permission can include a value representing a maximum allowable number of incremental mode shifts between the operating mode selection parameters and the preferred operating mode 332. In one such example, the selected operating modes may fall on an integer scale; for example, mode 0=e-reader, mode 1=monochrome, mode 2=power saver, mode 3=normal, mode 4=vivid, etc. In this example, if the current selected operating mode is 0 (e-reader mode) and the preferred operating mode is 3 (normal mode), and the permission allows two incremental mode shifts, the IFCSL 305 will increase the selected operating mode 310 from 0 to 2 (power saver mode). If the permission allows three incremental mode shifts, however, the IFCSL 305 will increase the selected operating mode 310 from 0 to 3 (normal mode).

In another such example, the incremental mode shift may apply to one or more individual image formation characteristics 315. In this example, the color bit depth may be expressed as an integer value on a scale of 1 to 10. The content item metadata 330 may include a preferred operating mode 332 calling for a color bit depth of 10 for maximum impact of the content item, and further include the fourth permission code corresponding to a maximum allowable number of mode shifts equal to 3. If the user-generated operating mode selection parameter includes a color bit depth of 7, for example, the IFCSL 305 can increase the color bit depth by 3 incremental steps to set the color bit depth to 10, thus displaying the content at the preferred color bit depth level. In another example, if the user-generated operating mode selection parameters 325 includes a color bit depth of 4, the IFCSL 305 can increase the color bit depth by 3 incremental steps to set the color bit depth to 7. Although the content will not be displayed at the full color bit depth requested by the preferred operating mode 332, a significant improvement in image quality of the content can still be achieved, thus fulfilling the purpose of the enhanced permission.

It is also possible for a permission to allow access to a mode not otherwise accessible via device-generated or user-generated selection parameters. For example, the permission may allow the content to be displayed via an “ultra-vivid” mode with image formation characteristics 315 at even higher levels than vivid mode, or an “e-reader plus red” mode, allowing red content to show during the otherwise black-and-white e-reader mode. Another example of a unique mode that could be accessed with the right permission would be one where one of the image formation characteristics 315 is made locally different in one region of the display, such as a higher brightness in the lower third (or any other suitable region) of the display.

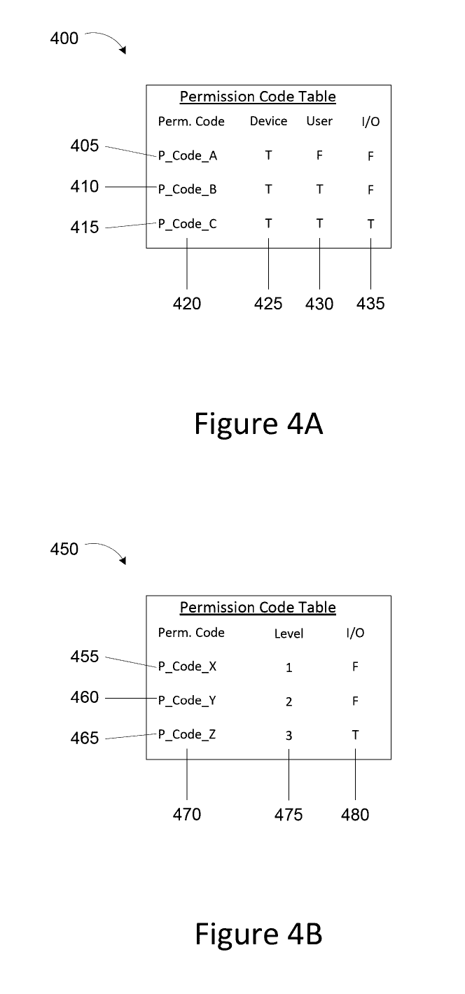

FIGS. 4A and 4B show example permission code tables 400 and 450. The permission code table 400 can define permissions for given permission codes 420. The rows of the permission code table 400 can correspond to permissions associated with each permission codes 420, including for example the permissions in row 405 corresponding to “P_Code_A,” and the permissions in row 410 corresponding to “P_Code_B,” etc. The columns of the permission code table 400 can correspond to individual permissions. The permissions shown in the permission code table 400 are in a true/false, yes/no, or 1/0 format; for example, the permissions in column 425 can indicate whether the given permission code will cause the IFCSL 305 to disregard device-generated operating mode selection parameters 320. Similarly, the permissions in column 430 can indicate whether the given permission code will cause the IFCSL 305 to disregard a user-provided operating mode selection parameter 325. The permissions in column 435 can indicate whether the given permission code will cause the IFCSL 305 to grant the content item access to other input/output functions of the display apparatus 128 or host device 120, such as a haptic output (vibration), audio output, ambient light sensor, accelerometer, microphone, or camera.

In the permission code table 400, the first permission code 405 can correspond to permissions that will cause the IFCSL 305 to disregard device-generated operating mode selection parameters 320, but not user-generated operating mode selection parameters 325. The second permission code 410 can correspond to permissions that will cause the IFCSL 305 to disregard user-generated operating mode selection parameters 325, and possibly device-generated operating mode selection parameters 320 as well. The third permission code 415 can correspond to permissions that will cause the IFCSL 305 to allow access to additional input/output functions.

The permission code table 450 can define permissions for given permission codes 470. The rows of the permission code table 450 can correspond to individual permission codes 470 and their corresponding permissions; for example, a first permission code “P_Code_X,” in row 455 and the corresponding permissions in columns 475 and 480, etc. The columns of the permission code table 450 can correspond to individual permissions; for example, column 475 can correspond to a value representing a maximum allowable number of incremental mode shifts between the currently selected operating mode selection parameters and the preferred operating mode 332. For example, the three permission codes 470 reflected in permission code table 450 have corresponding permission values of 1, 2, or 3, respectively. The permission code table 450 also has a column 480 that can indicate whether the given permission code will cause the IFCSL 305 to grant the content item access to other input/output functions of the display apparatus 128 or host device 120, similar to column 435 shown in FIG. 4A.

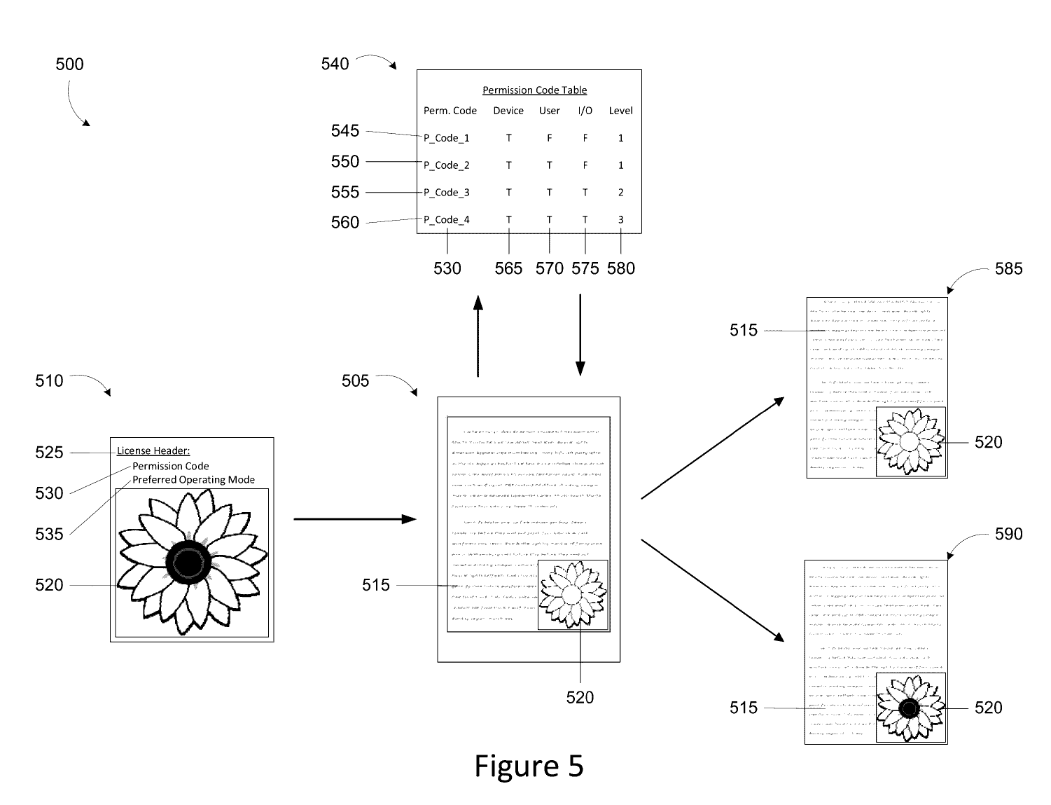

FIG. 5 illustrates an example operation 500 of permissions based control of third-party selection of display operating modes. A display apparatus 505 can be an example of the display apparatus 128 shown in FIG. 1B. The display apparatus 505 can include the Image Formation Characteristics Selection Logic (IFCSL 305) shown in FIG. 3. The display apparatus 505 can receive a content item 510 and display it with the primary content 515, for example, by displaying it alongside, or superimposed upon, primary content 515. The content item 510 can include content 520 for display by display apparatus 505. The content 520 can include an image, text, animated picture format, video, or the like. The content item 510 can include a license header 525, which can contain a permission code 530 and a preferred operating mode 535. The display apparatus 505 can compare the permission code 530 to a permission code table 540 to determine one or more permissions. Based on the permissions and the preferred operating mode 535, the display apparatus 505 can change the selected operating mode or image formation characteristics when displaying the content 520 of content item 510. The content item 510 can be from the same provider, or a different provider, as the primary content 515. Furthermore the content item 510 can come to the display apparatus 505 via the same path, or via a different path, as the primary content 515. For example, the primary content 515 may come to the display apparatus 505 from a website streaming over a local area network (such as Wi-Fi), while the content item 510 may come from the same website over the same local area network, or from a social media feed over a cellular network (e.g., 3G, 4G, LTE, etc.), or from a local area source over a wireless charging connection, etc.

The example operation 500 shows two example renderings 585 and 590 of the content 520 alongside primary content 515. The first example rendering 585 results when the permission code 530 is insufficient to cause the display apparatus 505 to change to the current selected operating mode or image formation characteristics. In the first example rendering 585, the user has set the user-provided operating mode selection parameter to the e-reader mode, as may be appropriate for conserving power when displaying text as primary content 515. In the e-reader mode, the display apparatus 505 displays primary content 515 in binary black and white with no grayscale. In the first example rendering 585, the permissions corresponding to permission code 530 do not cause the display apparatus 505 to change the selected operating mode or the image formation characteristics for display of the content 520. For example, the permission code 530 may be P_Code_1, corresponding to the first permissions in row 545. According to the permission code table 540, the permissions in row 545 will cause the display apparatus 505 to disregard device-generated operating mode selection parameters 565 in favor of the preferred operating mode 535. The first permission code 545 will not, however, cause the display apparatus 505 to disregard user-provided operating mode selection parameters 570. As a result, the display apparatus 505 displays the content 520 in black and white in accordance with the current selected operating mode and image formation characteristics as specified by the user's mode selection.

In the second example rendering 590, the permissions are sufficient to allow alteration of the image formation characteristics for display of content 520. For example, the permission code 530 may be P_Code_2, corresponding to the permissions in row 550. According to the permission code table 540, the permissions in row 550 can cause the display apparatus 505 to disregard both device-generated operating mode selection parameter 565 and user-provided operating mode selection parameter 570 in favor of the preferred operating mode 335. The display apparatus 505 thus displays the content 520 according to the selected operating mode or image formation characteristics described in the preferred operating mode 535. As a result, the display apparatus 505 displays the content 520 in color despite the user's mode selection.

In some operations, and subject to the appropriate permissions, the content item can be an interactive content item 510 with access to additional user interface features. For example, the content item 510 can respond to touch or gesture commands received by the display apparatus 505 via a touchpad coupled to the host device 120, or data from an eye or head tracking system that uses a camera of the host device 120. For example, the display apparatus 505 can adjust the position, appearance, content, or display qualities of the content item 510 based on the user's attention. This information can be passed to the provider of the content item 510 or otherwise used to improve the user experience.

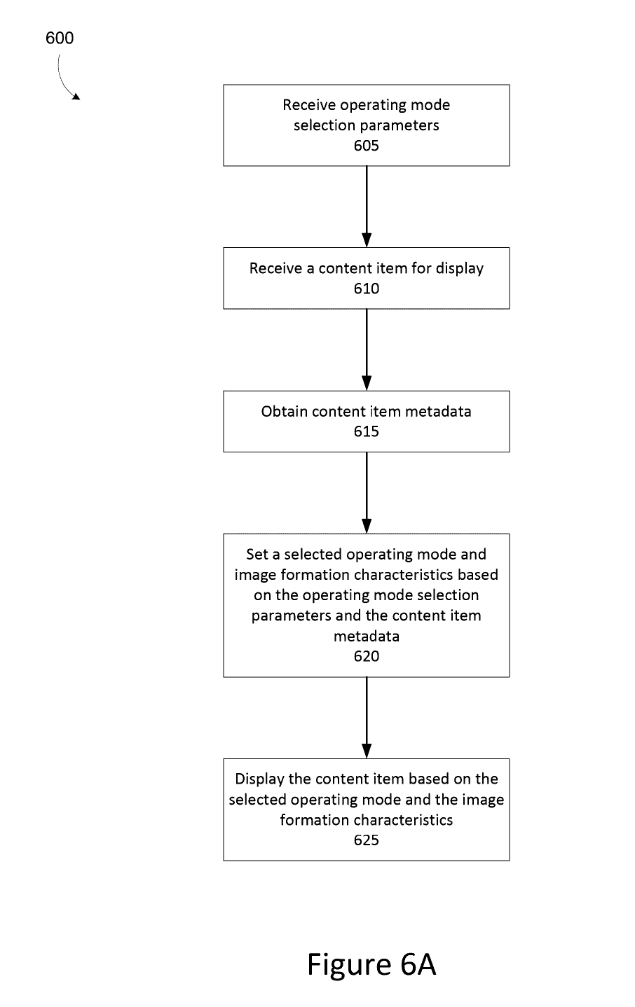

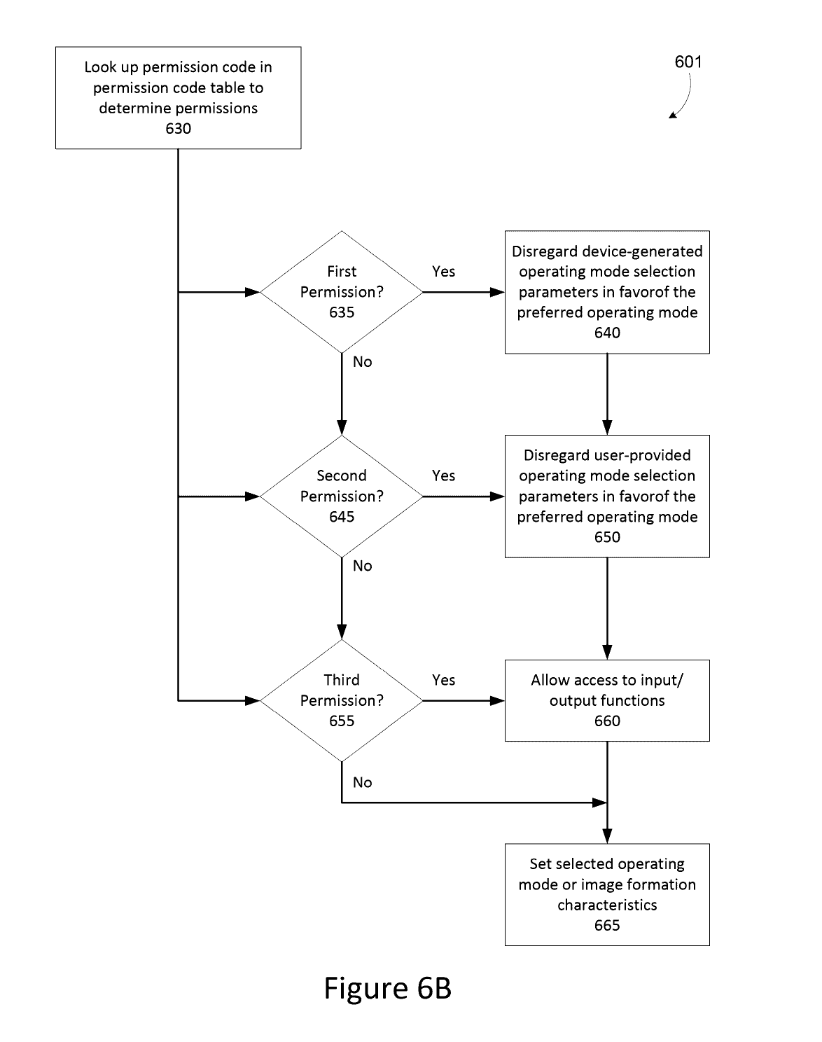

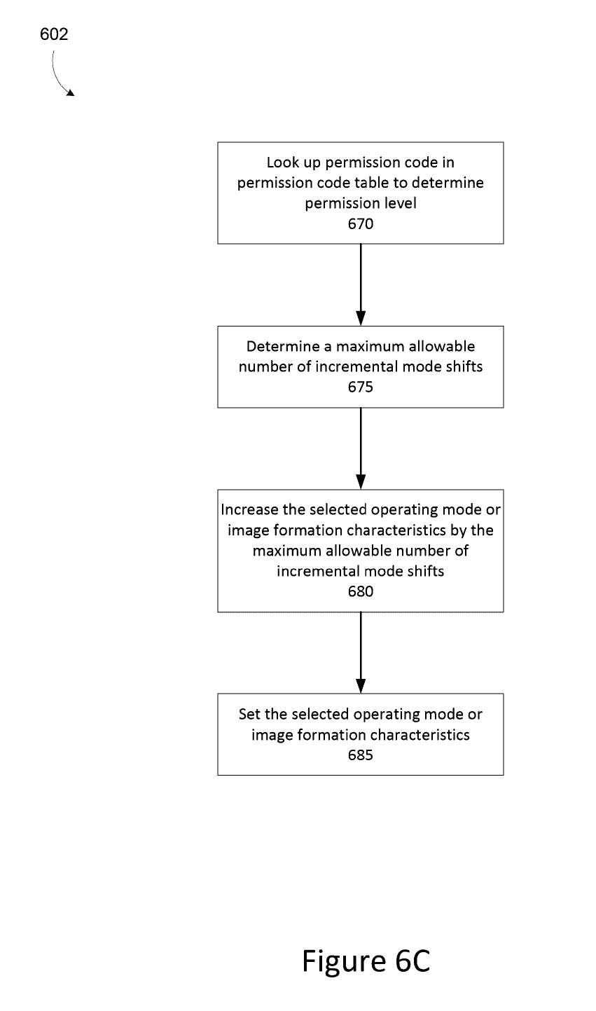

FIG. 6A shows a flow diagram of an example process 600 for permissions based control of third-party selection of display operating mode. The process 600 includes receiving operating mode selection parameters (stage 605), receiving a content item for display (stage 610), obtaining content item metadata (stage 615), setting the selected operating mode and image formation characteristics based on the operating mode selection parameters and content item metadata (stage 620), and displaying the content item based on the selected operating mode (stage 625). This process can be carried out, for example, by the display apparatus 128 shown in FIG. 1B, which can include the Image Formation Characteristic Selection Logic 305 shown in FIG. 3.

Referring to FIGS. 1B and 6A, the process 600 includes receiving operating mode selection parameters (stage 505). The display apparatus 128 can receive one or more device-generated operating mode selection parameters, user-provided operating mode selection parameters, or both. The display apparatus 128 can receive the device-generated operating mode selection parameters from the host device 120. The device-generated operating mode selection parameters can be based on input from the host processor 122, environmental sensors 124 such as an ambient light sensor, and a user input module 126. The device-generated operating mode selection parameters can include at least one of a power consumption parameter, a battery level parameter, a color level, a content type, or an application type. The power consumption parameter can include one of a high-performance mode, an economy or power-saver mode, or a stand-by mode. The battery level parameter can include one of a battery full mode, a low battery mode, or a battery critical mode. Alternatively, the battery level parameter can be a quantitative representation of the proportion of battery charge remaining. The color level can include a color bit depth, and can also include a color gamut size. The content type can include color video, grayscale video, color image, grayscale image, text only, or the like. The application type can include one of a video player, an image gallery, a text-only application, a multi-media application, a web browser, a map or GPS application, or the like. The device-generated operating mode selection parameters can depend on a color content of the image data, metadata of the image data, an ambient brightness, or a battery level. The color content of the image data can dictate the device-generated operating mode selection parameters; for example, the display apparatus 128 can adjust the color level depending on whether the image type corresponds to a high or low color bit depth or color gamut size. The ambient brightness as measured by the environmental sensors 124 can also dictate a device-generated operating mode selection parameters; for example, the display apparatus 128 can adjust display brightness according to an ambient light level. In addition, the display apparatus 128 can adjust the color level commensurate with the brightness level, since a display with reduced brightness may not benefit from for a full color depth level or a full color gamut level. The battery level can also dictate a device-generated operating mode selection parameters; for example, the display apparatus 128 can adjust the selected operating mode or image formation characteristics to maintain an image quality appropriate for the remaining battery charge.

The display apparatus 128 can receive one or more user-generated operating mode selection parameters from the host device 120. The user-generated operating mode selection parameters can include the same parameters as the device-generated operating mode selection parameters discussed above. In general, however, the user-generated operating mode selection parameters can be given higher priority over the device-generated operating mode selection parameter. That is, the device-generated operating mode selection parameters can be a set of defaults implemented by the host device 120 in absence of preferences set by a user of the host device 120. Any user-generated operating mode selection parameters entered can take priority over these defaults. According to this system of priorities, a separate or higher permission may be required to allow changes to the selected operating mode and image formation characteristics based on the user-generated operating mode selection parameters.

The process 600 includes receiving a content item for display (stage 610). The content item for display can be an image, video, text, or other format appropriate for display by the display apparatus 128. The content item for display can be primary content requested by the user, a content item provided to fill a slot in the primary content, or a content item to overlay the primary content. For example, the content item for display can be an announcement, application notification, network notification, emergency broadcast, or the like. The content item for display can include image, video, or text data and further include metadata.

The process 600 includes receiving content item metadata (stage 615). The content item for display can include metadata containing a license header having a permission code and a preferred operating mode. The preferred operating mode can include a selected operating mode or image formation characteristics preselected for optimum viewing of the content item.

The process 600 includes setting a selected operating mode and image formation characteristics based on the operating mode selection parameters and the content item metadata (stage 620). The display apparatus 128 can take the received permission code and check it against a permission code table stored in a memory associated with the display apparatus 128. The display apparatus 128 can determine from the permission code table one or more permissions corresponding to the permission code. The display apparatus 128 can set the selected operating mode or image formation characteristics based on an analysis of the operating mode selection parameters, the preferred operating mode, and the permission. The determination of the selected operating mode is discussed in further detail below with regard to FIGS. 6B and 6C.

The process 600 includes displaying the content item based on the selected operating mode and the image formation characteristics (stage 625). The display apparatus 128 can display the content item according to the selected operating mode or image formation characteristics set in stage 620. The display apparatus 128 can transmit the appropriate commands to the light modulators 150 and the lamp drivers 148 to display the content item at the appropriate brightness level, color level, and frame rate for the selected operating mode and image formation characteristics. The display apparatus 128 can display the content item on a portion of the display or across the entire display. In situations where the content item is displayed within a portion of the display, the display apparatus 128 can display the content item according to the selected operating mode, and can continue to operate the rest of the display according to the operating mode selection parameters. Alternatively, the display apparatus 128 can apply the selected operating mode or image formation characteristics to the entire display.

FIG. 6B shows a flow diagram of an example process 601 for permissions based control of third-party selection of display operating mode. The process 601 can be performed, for example, as part of stage 620 described above with regard to FIG. 6A. The process 601 includes looking up the permission code in the permission code table to determine permissions (stage 630). The process 601 includes determining whether the permission code corresponds to a first permission (stage 635) and, if so, disregarding device-generated operating mode selection parameters in favor of the preferred operating mode (stage 640). If the permission code does not correspond to the first permission, the process 601 can continue by determining whether the permission code corresponds to any other permissions. The process 601 includes determining whether the permission code corresponds to a second permission (stage 645) and, if so, disregarding user-provided operating mode selection parameters in favor of the preferred operating mode (stage 650). If the permission code does not correspond to the second permission, the process 601 can continue by determining whether the permission code corresponds to any other permissions. The process 601 includes determining whether the permission code corresponds to a third permission (stage 655) and, if so, allowing access to additional input/output functions of the display apparatus or host device (stage 660). The process 601 includes setting the selected operating mode or the image formation characteristics according to the operating mode selection parameters, the preferred operating mode, and the permissions (stage 665). If the permission code does not correspond to any permissions, the process 601 can leave the selected operating mode and image formation characteristics unchanged.

The process 601 includes looking up the permission code in the permission code table to determine permissions (stage 630). The display apparatus 128 can check the permission code from the metadata obtained during stage 615 as shown in FIG. 6A against a permission code table stored in a memory. Permission code tables and their use are described above with regard to the permission code table 335 shown in FIG. 3, the permission code table 400 shown in FIG. 4A, the permission code table 450 shown in FIG. 4B, and the permission code table 540 shown in FIG. 5. The permission code table, and the process of looking up permission codes in the permission code table, can employ one or more techniques to enhance the security and integrity of the service, and prevent the reverse engineering of valid permission codes. For example, the permission code table can be updated periodically by a central authority. In that way, even if a permission code table is divulged, the effect will be limited in duration. In another example, the display apparatus 128 can apply a hash function to the permission code, and use the output of the hash function to look up permissions associated with the permission code in the permission code table. In that way, even if the permission code table were divulged, the permissions codes recorded therein would remain secure. In yet another example, the permission coded table can be split into two or more tables. In implementations with multiple tables, one or more tables can reside locally and one or more tables can reside remotely. In these examples, the permission code table can be encrypted or otherwise secured. In addition, the techniques in the previous examples are not mutually exclusive and can be applied in various combinations.

The process 601 includes determining whether the permission code corresponds to a first permission (stage 635) and, if so, disregarding device-generated operating mode selection parameters in favor of the preferred operating mode (stage 640). The display apparatus 128 can determine whether the permission code corresponds to a first permission; for example, the permission listed in column 425 for permission code table 400 shown in FIG. 4A. The first permission code in this example is a yes/no, true/false, 1/0 type permission. If there is a conflict between device-generated operating mode selection parameters and the preferred operating mode included in the metadata obtained during stage 615 as shown in FIG. 6A, the first permission can cause the display apparatus 128 to disregard the conflicting device-generated operating mode selection parameters in favor of the preferred operating mode. For example, the device-generated operating mode selection parameters may default to a normal display mode, while the preferred operating mode may specify a vivid, or enhanced, display mode. If the permission code table associates the permission code with the first permission, the display apparatus 128 will disregard the device-generated operating mode selection parameters' specification of the normal display mode, and instead set the selected operating mode to the vivid display mode. In another example, the device-generated operating mode selection parameter may specify image formation characteristics including a backlight brightness level of 50% based on the ambient light sensed by environmental sensors 124, while the preferred operating mode may specify image formation characteristics including a brightness level of at least 75%. If the permission code table associates the permission code with the first permission, the display apparatus 128 will disregard the device-generated operating mode selection parameters' specification of a 50% brightness level, and instead set the image formation characteristics to a brightness level of 75%. In other examples, the preferred operating mode can specify a combination of a selected operating mode and image formation characteristics.

The process 601 includes determining whether the permission code corresponds to a second permission (stage 645) and, if so, disregarding conflicting, or, in some implementations, all user-provided operating mode selection parameters in favor of the preferred operating mode (stage 650). These stages are performed similarly to stages 635 and 640 described above, but with the second permission causing the display apparatus 128 to disregard the user-provided operating mode selection parameters in favor of the preferred operating mode.

The process 601 includes determining whether the permission code corresponds to a third permission (stage 655) and, if so, allowing access to additional input/output functions of the display apparatus 128 or the host device 120 (stage 660). Examples of output functions can include a haptic output (vibration) or audio output. For example, a content item having a permission code corresponding to a third permission can cause the display apparatus 128 or the host device 120 to activate the haptic output and cause a vibration to gain the attention of a user. In another example, the content item can cause the display apparatus 128 or the host device 120 to output a ringtone, voice, music, sound effect, or other audio. Examples of input functions can include access to an ambient light sensor, accelerometer, microphone, or camera of the display apparatus 128 or the host device 120. Access to these functions can increase the interactive abilities of the content item. For privacy reasons, the display apparatus 128 or the host device 120 may only allow access to input functions subject to the approval of the user of the device.

The process 601 includes setting the selected operating mode or the image formation characteristics according to the operating mode selection parameters, the preferred operating mode, and the permissions granted (stage 665). Based on the determinations of permissions and priority made in stages 635, 640, 645, 650, 655, and 660 above, the display apparatus 128 can set the selected operating mode or the individual image formation characteristics for display of the content item, and grant appropriate access to the additional input and output functions.

FIG. 6C shows a flow diagram of another example process 602 for permissions based control of third-party selection of display operating mode. The process 602 can be performed, for example, as part of stage 620 described above with regard to FIG. 6A. The process 602 includes looking up the permission code in the permission code table to determine the permission level (stage 670), determining a maximum allowable number of incremental mode shifts between the operating mode selection parameters and the preferred operating mode (stage 675), increasing the level of the selected operating mode or the image formation characteristics up to the maximum allowable number of incremental mode shifts not to exceed the corresponding parameter of the preferred operating mode (stage 680), and setting the selected operating mode or image formation characteristics (stage 685).

The process 602 includes looking up the permission code in the permission code table to determine the permission level (stage 670). This stage is similar to stage 630 discussed above with regard to FIG. 6B. In this stage 670, however, the permission obtained can be a numerical value rather than a yes/no permission. For example, the numerical permission can be of the type reflected in column 475 of permission code table 450 shown in FIG. 4B or column 580 of permission code table 540 shown in FIG. 5. The display apparatus 128 can check the permission code from the metadata obtained during stage 615 as shown in FIG. 6A against the permission code table. Permission code tables and their use were described previously with regard to permission code table 450 of FIG. 4B and permission code table 540 of FIG. 5. The permission code table, and the process of looking up permission codes in the permission code table, can employ one or more techniques to enhance the security and integrity of the service, and prevent the reverse engineering of valid permission codes, as described above with regard to stage 630 shown in FIG. 6B.

The process 602 includes determining a maximum allowable number of incremental mode shifts between the operating mode selection parameters and the preferred operating mode (stage 675). The permission returned by stage 670 can be a numerical value. The numerical permission can, for example, represent a stepwise increase in the selected operating mode. In such an example, the selected operating modes may fall on an integer scale; for example, mode 0=e-reader, mode 1=monochrome, mode 2=power saver, mode 3=normal, mode 4=vivid, etc. The numerical permission can indicate how many incremental mode shifts the display apparatus 128 may apply to increase the operating mode to bring it up to the level specified by the preferred operating mode. In another example, the numerical permission may apply to one or more individual image formation characteristics, such as color bit depth. For example, the color bit depth may be expressed as a integer value. In such an example, the numerical permission can indicate how many incremental mode shifts the display apparatus 128 may apply to increase the color bit depth to bring it up to the level specified by the preferred operating mode. The numerical permission can apply to other image formation characteristics in a similar manner.

The process 602 includes increasing the level of the selected operating mode or the image formation characteristics up to the maximum allowable number of incremental mode shifts not to exceed the corresponding parameters of the preferred operating mode (stage 680). For a numerical permission associated with a selected operating mode, the display apparatus 128 can increase the selected operating mode by a number of incremental mode shifts specified by the numerical permission up to the level specified by the preferred operating mode. If, for example, the current selected operating mode is 0 (the e-reader mode) and the preferred operating mode is 3 (the normal mode), and the permission allows two incremental mode shifts, the display apparatus 128 will increase the selected operating mode from 0 to 2 (into the power saver mode). If the permission allows three incremental mode shifts, however, the display apparatus 128 will increase the selected operating mode from 0 to 3 (into the normal mode). For a numerical permission associated with individual image formation characteristics, the display apparatus 128 can increase the value of the individual image formation characteristic by a number of incremental mode shifts specified by the numerical permission up to the level specified by the preferred operating mode. For example, the color bit depth level may fall on a scale of 1 to 10 bits per color. The preferred operating mode may specify a color bit depth of 10 for maximum impact of the content item, and further include a numerical permission corresponding to a maximum allowable number of incremental mode shifts equal to 3. If the current selected operating mode includes a color bit depth of 7, for example, the display apparatus 128 can increase the color bit depth by 3 incremental steps to set the color bit depth to 10, thus displaying the content at the preferred color bit depth level. In another example, if the current selected operating mode includes a color bit depth of 4, the display apparatus 128 can increase the color bit depth by 3 incremental steps to set the color bit depth to 7. In this example, even though the content will not be displayed at the full color bit depth requested by the preferred operating mode, a significant improvement in image quality of the content can still be achieved, thus fulfilling the purpose of the permissions based control of third-party selection of display operating mode. In some operations, the numerical permission can be scaled when applied to individual image formation characteristics. For example, if the color gamut size falls on a 100-point scale, a numerical permission equal to 3 may be scaled by a factor of 10, to allow for an incremental mode shift of 30 points on the 100-point scale. In other operations, the permission code table can specify an array of numerical permissions, where each element of the array applies to a different individual image formation characteristic. In some operations, the numerical permission is sufficient to cause the display apparatus 128 to alter the current selected operating mode. In other operations, the display apparatus 128 will require a yes permission in addition to the numerical permission in order to alter the current selected operating mode. In other operations, the permission code table can specify more than one numerical permission; for example, to apply depending on whether the operating mode selection parameters were device-generated or user-provided.

The process 602 includes setting the selected operating mode or image formation characteristics (stage 685). Based on determinations made in stages 675 and 680 above, the display apparatus 128 can set the selected operating mode or the individual image formation characteristics for display of the content item.

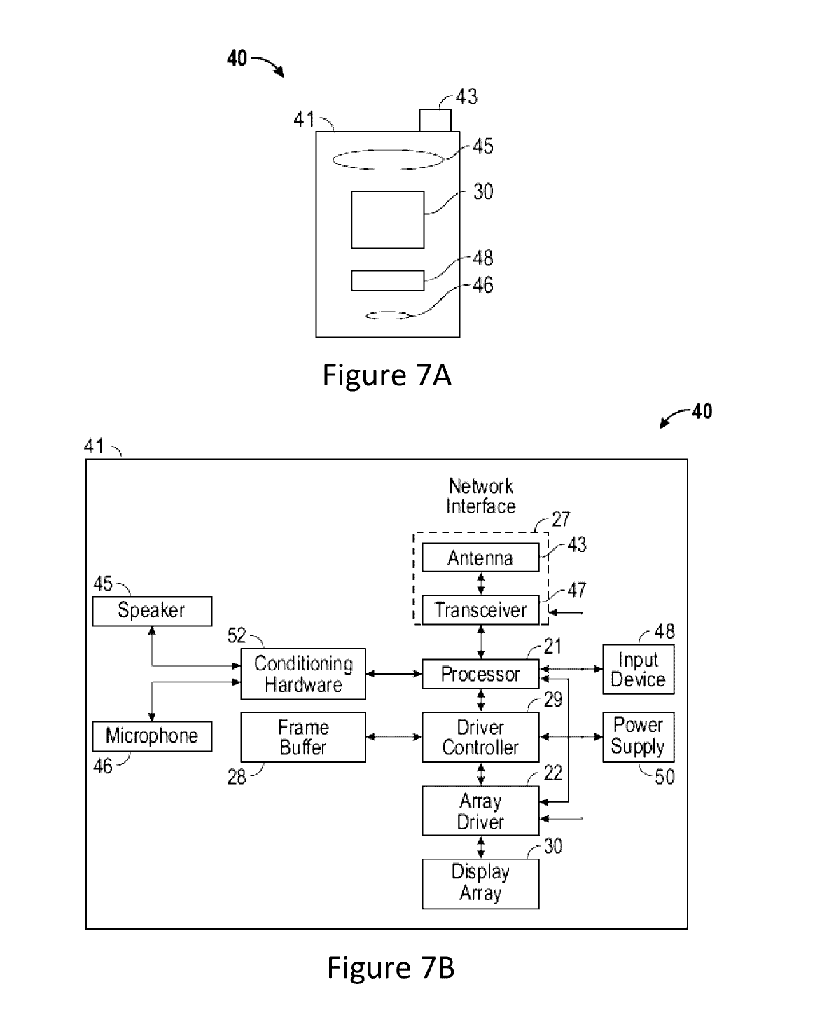

FIGS. 7A and 7B show system block diagrams of an example display device 40 that includes a plurality of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be capable of including a flat-panel display, such as plasma, electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 30 can include a mechanical light modulator-based display, as described herein.

The components of the display device 40 are schematically illustrated in FIG. 7B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 7A, can be capable of functioning as a memory device and be capable of communicating with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to any of the IEEE 16.11 standards, or any of the IEEE 802.11 standards. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G, or further implementations thereof, technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29 is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22 and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a bi-stable display controller (such as a mechanical light modulator display element controller). Additionally, the array driver 22 can be a conventional driver or a bi-stable display driver (such as a mechanical light modulator display element controller). Moreover, the display array 30 can be a conventional display array or a bi-stable display array (such as a display including an array of mechanical light modulator display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40. Additionally, in some implementations, voice commands can be used for controlling display parameters and settings.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

1. An apparatus comprising:
a controller having a processor configured to:
receive one or more of a user-provided operating mode selection parameter or a device-generated operating mode selection parameter,
receive a content item for display, the content item including image data and metadata containing a license header having a permission code and a preferred operating mode, and
analyze the permission code, the preferred operating mode, and the one or more of the user-provided operating mode selection parameter or the device-generated operating mode selection parameter to determine the operating mode; and
a display configured to display the content item in the operating mode.

2. The apparatus of claim 1, wherein the operating mode corresponds to a set of image formation characteristics.

3. The apparatus of claim 2, wherein the image formation characteristics include at least one of bit depth, frame rate, color gamut, and brightness.

4. The apparatus of claim 1, further comprising a haptic output device, and wherein the operating mode includes access to an additional output function associated with the haptic output device.

5. The apparatus of claim 1, further comprising a computing device, and wherein the operating mode includes access to an audio file stored in a memory of the computing device.

6. The apparatus of claim 1, wherein the user-provided operating mode selection parameter includes at least one of a display brightness level, a color level preference, a power consumption preference, and a mode selection.

7. The apparatus of claim 1, wherein the device-generated operating mode selection parameter includes at least one of a power consumption preference, a battery power level parameter, a color level, a content type, and an application type.

8. The apparatus of claim 7, wherein the device-generated operating mode selection parameter depends on a color content of the image data, metadata of the image data, an ambient brightness, and a battery power level.

9. The apparatus of claim 1, the controller configured to analyze the permission code by comparing the permission code against a permission code table to determine one or more permissions.

10. The apparatus of claim 9, wherein the permission code table defines a first permission and a second permission, wherein:
the first permission allows alteration of image formation characteristics based on the user-provided operating mode selection parameter; and
the second permission allows alteration of image formation characteristics based on the device-generated operating mode selection parameter.

11. The apparatus of claim 10, wherein the permission code table defines a third permission, wherein the third permission allows access to an additional output function.

12. The apparatus of claim 11, wherein:
the values of the preferred operating mode, the user-provided operating mode selection parameter, and the device-generated operating mode selection parameter represent an incremental level,
the preferred operating mode consists of a desired level, and
analyzing the permission code, the preferred operating mode, and the one or more of the user-provided operating mode selection parameter or the device-generated operating mode selection parameter includes determining a maximum allowable number of incremental mode shifts between the one or more of the user-provided operating mode selection parameter or the device-generated operating mode selection parameter and the desired level.

13. The apparatus of claim 1, further comprising:
a display;
a processor capable of communicating with the display, the processor being capable of processing image data; and
a memory device capable of communicating with the processor.

14. The apparatus of claim 13, further comprising:
a driver circuit capable of sending at least one signal to the display; and
a controller capable of sending at least a portion of the image data to the driver circuit.

15. The apparatus of claim 13, further comprising:
an image source module capable of sending the image data to the processor, wherein the image source module includes at least one of a receiver, transceiver, and transmitter.

16. The apparatus of claim 13, further comprising:
an input device capable of receiving input data and communicating the input data to the processor.

17. A computer-implemented method for determining an operating mode of a display apparatus, the method comprising:
receiving, by a processor associated with the display apparatus, one or more of a user-provided operating mode selection parameter or a device-generated operating mode selection parameter;
receiving, by the processor, a content item for display, the content item including image data and metadata containing a license header having a permission code and a preferred operating mode;
analyzing, by the processor, the permission code, the preferred operating mode, and the one or more of the user-provided operating mode selection parameter or the device-generated operating mode selection parameter to determine the operating mode; and
displaying the content item in the operating mode.

18. The method of claim 17, wherein the operating mode corresponds to a set of image formation characteristics.

19. The method of claim 18, wherein the image formation characteristics include at least one of bit depth, frame rate, color gamut, and brightness.

20. The method of claim 17, wherein the operating mode includes activation of a haptic output device.

21. The method of claim 17, wherein the display apparatus is associated with a computing device, and the operating mode includes access to an audio file stored in a memory of the computing device.

22. The method of claim 17, wherein the user-provided operating mode selection parameter includes at least one of a display brightness level, a color level preference, a power consumption preference, and a mode selection.

23. The method of claim 17, wherein the device-generated operating mode selection parameter includes at least one of a power consumption parameter, a battery power level parameter, a color level, a content type, and an application type.

24. The method of claim 23, wherein the device-generated operating mode selection parameter depends on a color content of the image data, metadata of the image data, an ambient brightness, and a battery power level.

25. The method of claim 17, wherein analyzing the permission code comprises comparing the permission code against a permission code table to determine one or more permissions.

26. The method of claim 25, wherein the permission code table defines a first permission and a second permission, wherein:
the first permission allows alteration of image formation characteristics based on the user-provided operating mode selection parameter; and
the second permission allows alteration of image formation characteristics based on the device-generated operating mode selection parameter.

27. The method of claim 26, the permission code table defining a third permission, wherein the third permission allows access to an additional output function.

28. The method of claim 17, wherein:
the values of the preferred operating mode, the user-provided operating mode selection parameter, and the device-generated operating mode selection parameter represent an incremental level,
the preferred operating mode includes a desired level, and
analyzing the permission code, the preferred operating mode, and the one or more of the user-provided operating mode selection parameter or the device-generated operating mode selection parameter includes determining a maximum allowable number of incremental mode shifts between the one or more of the user-provided operating mode selection parameter or the device-generated operating mode selection parameter and the desired level.
